(19) United States
(12) Patent Application Publication
(10) Pub. No.: US 2018/0335902 A1
(43) Pub. Date: Nov. 22, 2018

(54) TECHNIQUES FOR DYNAMICALLY DISPLAYING RELEVANT FILES FOR SELECTION

(71) Applicant: Apple Inc., Cupertino, CA (US)

(72) Inventors: Yan ARROUYE, Los Altos, CA (US); Johannes B. FORTMANN, San Francisco, CA (US); Jean-Gabriel MORARD, Chaville (FR); Alexandre CARLHIAN, Paris (FR); Pau SASTRE MIGUEL, Paris (FR); Pierre d'HERBEMONT, San Francisco, CA (US)

(21) Appl. No.: 15/905,782

(22) Filed: Feb. 26, 2018

Related U.S. Application Data
(60) Provisional application No. 62/507,160, filed on May 16, 2017.

(51) Int. Cl. G06F 3/0482; G06F 17/30

(52) U.S. Cl. CPC G06F 3/0482; G06F 17/30112

(57) ABSTRACT

This application relates to techniques for dynamically displaying relevant files for selection by a user at a computing device. The technique can provide a file browser that, upon detection of a file selection, performs enumeration procedures on a file access service that provides the file. The results of the enumeration procedures are utilized by a file provider daemon to synchronize locally cached files that fall under the domain of at least one file access service. Using key property data identified by the file provider daemon, a file access service responsible for a locally cached file can communicate an updated version of the locally cached for receipt by the file browser. The file browser can then display the updated version of the locally cached file within a pre-defined category for quick access by the user.

### CROSS-REFERENCE TO RELATED APPLICATIONS

The present application claims the benefit of U.S. Provisional Application No. 62/507,160, entitled “TECHNIQUES FOR DYNAMICALLY DISPLAYING RELEVANT FILES FOR SELECTION,” filed May 16, 2017, the content of which is incorporated herein by reference in its entirety for all purposes.

### FIELD OF INVENTION

The described embodiments relate generally to file selection techniques. More particularly, the present embodiments relate to techniques for dynamically displaying relevant files for selection by a user at a computing device.

### BACKGROUND

Modern computing systems generally utilize a file selection mechanism known as a “file picker,” which is a graphical user interface tool that allows a user to select a file to be accessed. However, conventional methods for implementing file selection using a file picker are often deficient because, among other issues, the file picker fails to present files of interest to a user in an efficient and meaningful manner. For instance, a file system generally includes a number of different folders, where each folder stores a number of different files. Often times, the user is not familiar with the manner in which the folders are organized within the file system. Consequently, the user is often required to painstakingly navigate through several different folders in order to find a file of interest. Thus, the conventional methods for selecting a file of interest can be a cumbersome experience to the user, especially when the user is seeking to quickly locate and access a relevant file.

### SUMMARY

Accordingly, the representative embodiments set forth herein disclose techniques for dynamically displaying relevant files for selection by a user at a computing device.

One embodiment sets forth a method for displaying files for selection at a computing device. In particular, the method involves, at the computing device, (1) identifying, among at least one file access service of a plurality of file access services, a first plurality of files associated with the at least one file access service, in which the first plurality of files is enumerated according to a first enumeration logic enforced by the at least one file access service, (2) receiving a selection of a key property, (3) selecting a first subset of files from the first plurality of files, in which the first subset of files includes a relevant set of files based on the key property, and (4) displaying the first subset of files for selection.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of a system that can be configured to perform the various techniques described herein, according to some embodiments.

FIGS. 2A-2E illustrate exemplary file enumeration/synchronization procedures that can be performed to enable relevant files associated with a local file system to be efficiently accessed, according to some embodiments.

FIGS. 2F-2J illustrate exemplary file enumeration/synchronization procedures that can performed to enable relevant files associated with a cloud-based file system to be efficiently accessed, according to some embodiments.

FIGS. 3A-3C and 4A-4C illustrate exemplary file enumeration/synchronization procedures that can be performed to enable relevant files associated with customizable categories to be efficiently accessed, according to some embodiments.

FIG. 5 illustrates an exemplary customized folder that includes different views for intelligently displaying relevant files for selection, according to some embodiments.

FIG. 6 illustrates a method for dynamically displaying relevant files for selection, according to some embodiments.

FIG. 7 illustrates an additional method for dynamically displaying relevant files for selection, according to some embodiments.

FIG. 8 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

As previously described herein, given the different configurations in which folder hierarchies can be organized, a user can often experience difficulty when attempting to locate/access files of interest. To cure this deficiency, the embodiments set forth herein provide various techniques that can enable the user to quickly access files of interest by eliminating the need, when attempting to locate/access files of interest, to understand/manually parse the folder hierarchies.

According to some embodiments, a file browser can generate customizable user interfaces that allow a user to efficiently locate/access files of interest. As described in greater detail herein, the file browser can perform enumeration procedures on a file access service (e.g., a local file system, a cloud-based file system, etc.) that provides the file. The file browser can also, using the results of the enumeration procedures, identify the manner in which the file access service organizes the folders/files that it is configured to manage. Additionally, the results of the enumeration procedures can be utilized by a file provider daemon to synchronize locally cached files that fall under the domain of the file access service. For instance, the file provider daemon can perform synchronization procedures that (1) identify key (i.e., important/relevant) property data associated with locally cached files that are of interest to the user, and (2) communicate the key property data to the file access service that is responsible for providing a particular locally cached file of interest to the user. According to some embodiments, the key property data can enable the responsible file access service to communicate, to the file provider daemon, an updated version of the locally cached file of interest to the user. Upon receipt of the updated version of the locally cached file, the file browser can display, using a customizable user interface, the updated version of the cached file within a pre-defined category, thereby providing quick-access results. Note that any reference to daemon can, also or in addition, refer to any software, thread, or process. A non-limiting example of a daemon is a process or program that runs as a background process and that can wait for events or times to perform operations.

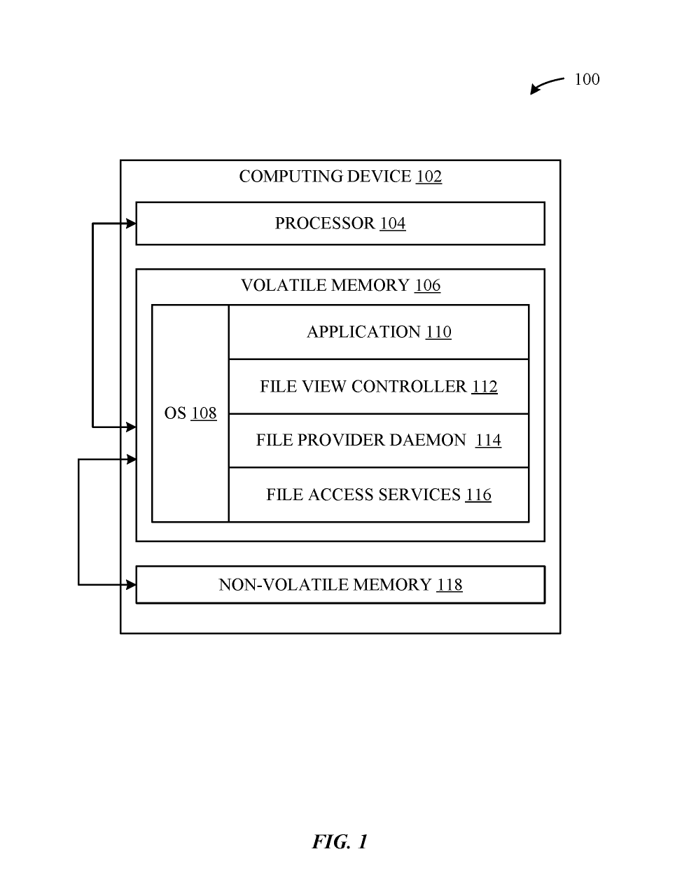

A more detailed description of the various techniques described herein, and the manner in which they can be implemented, is provided below in conjunction with FIGS. 1, 2A-2J, 3A-3C, 4A-4C, and 5-8.

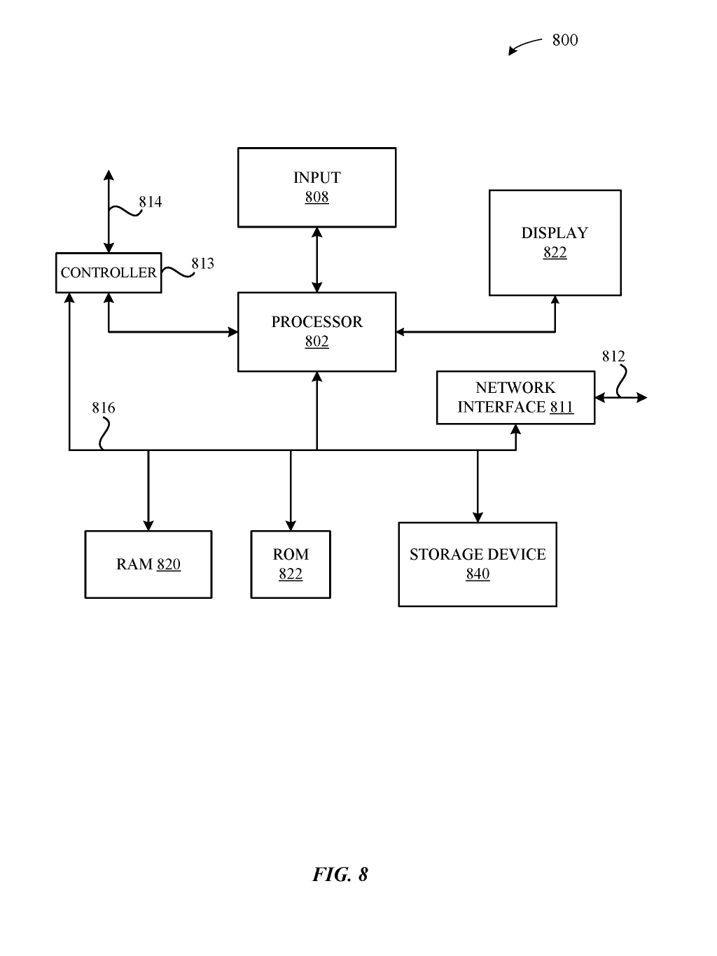

FIG. 1 illustrates a high-level overview 100 of a computing device 102 that can be configured to perform the various techniques described herein. As shown in FIG. 1, the computing device 102 can include a processor 104, a volatile memory 106 (e.g., a Random-Access Memory (RAM)), and a non-volatile memory 118 (e.g., a storage device). It is noted that a more detailed breakdown of example hardware components that can be included in the computing device 102 is illustrated in FIG. 8, and that these components are omitted from the illustration of FIG. 1 merely for simplification purposes. For example, the computing device 102 can include additional non-volatile memories (e.g., solid state drives, hard drives, etc.), other processors (e.g., a multi-core central processing unit (CPU)), and the like. According to some embodiments, an operating system (OS) 108 can be loaded at the volatile memory 106, where the OS 108 can be enabled to execute a variety of applications that enable the various techniques described herein to be implemented. As described in greater detail herein, such applications can include an application 110, a file view controller 112, a file provider daemon 114, and a file access service 116.

According to some embodiments, the file view controller 112 can represent a file browser that operates independently from a host application, such as an application 110, and includes the functionality to generate user interfaces. For example, a user interface generated by file view controller 112 can be actively presented to a user via a display device (not illustrated in FIG. 1) that is communicably coupled to the computing device 102. As described in greater detail herein, a user interface generated by the file view controller 112 can include a number of different graphical user interface (GUI) button objects. Each GUI button object can be configured to cause the file view controller 112 to display, upon selection, one or more relevant files/folders to a user. A file can be at least any or a combination of documents, spreadsheets, presentations, messages, text, videos, audio files, images, and the like.

Also, as described in greater detail herein, the file view controller 112, using an enumeration logic, can perform enumeration procedures to gather information about a folder hierarchy implemented by a file system, such as a local file system, a cloud-based file system, and the like. According to some embodiments, the enumeration procedures performed by the file view controller 112 can include, but are not limited to, gathering data associated with (1) the manner in which folders within a file access service 116 are identified and/or queried; (2) the manner in which top-level folders and sub-level folders are organized relative to a root folder; (3) the manner in which folders are created and modified (e.g., adding a folder, deleting a folder, renaming a folder, etc.); (4) display folder attributes (e.g., tags, last used date, folder origin information, thumbnails, etc.); (5) the manner in which permissions can be set on folders; and so on.

Additionally, based on the resultant data generated from the enumeration procedures performed by the file view controller 112 or requested to be performed by file view controller 112, the file view controller 112 can assign an identifier for each enumerated file (e.g., name, type, status, etc.). In a similar manner, according to some embodiments, the file view controller 112 can assign an identifier for each enumerated folder. As described in greater detail herein, the file view controller 112 can assign identifiers to folders/files in a manner that allows the file provider daemon 114 to identify one or more relevant files and monitor status updates associated with each relevant file. In this fashion, the file view controller 112 can receive modification information associated with one or more relevant files that can be displayed to a user (e.g., via a user interface generated by the file view controller 112). It is noted that the term “modification” used throughout this disclosure can represent a condition under which a folder/file is modified on a computing device 102 and an updated version of the folder/file is to be propagated to at least one other computing device 102. For example, the modification information described herein can identify a folder/file name, a modification date associated with the folder/file, and identification of a source device on which the folder/file was modified, and so on.

According to some embodiments, the file view controller 112 can be configured to perform the various operations described herein in response to commands received via a standard input/output devices (e.g., keyboard, mouse, touchscreen, etc.). According to some embodiments, the file view controller 112 can also be configured to perform the various operations described herein in response to voice commands (e.g., commands received via a microphone device coupled to the computing device 102). For example, the file view controller 112 can be configured to automatically open one or more files specified by the user through voice commands, e.g., “dictate the most recent word processing document that I worked on,” “email Sam the spreadsheet I was just working on,” “ask Greg to review the most recent modifications I made to the presentation,” and so on. To implement this functionality, the computing device 102 can be capable of performing various language processing techniques to accurately deduce the user's intentions. In turn, the computing device 102 can utilize the various techniques described herein to provide meaningful functionality (as described above) that improves the user's overall experience.

According to some embodiments, the file provider daemon 114 can perform synchronization/enumeration procedures, using an enumeration logic, to monitor enumerated files included in an active set of files. According to some embodiments, an active set of files can include one or more files locally cached on the computing device 102 that are of interest to the user. As will be described in greater detail herein, the association of one or more files with an active set of files can be based on key (i.e., important/relevant) property data. Furthermore, as described in greater detail herein, the file provider daemon 114 can communicate, to the different file access services 116, key property data associated with an active set of files. In this fashion, the file provider daemon 114 can also receive, from a file access service provider in receipt of active set/key property data information, modification information associated with files included in an active set of files.

According to some embodiments, each file access service 116 of file access services 116 can provide access to a different file system, e.g., a local file system, a network file system, a cloud-based file system, and the like. As described in greater detail herein, each file access service 116 can perform enumeration procedures, using enumeration logic, for a set of files within the domain of the file access service 116. Each file access service 116 can also receive/communicate data related to an active set of files identified by the file provider daemon 114. As described in greater detail herein, each file access service 116 can also assist the file provider daemon 114 in providing the file view controller 112 with updated versions of relevant files for display to a user.

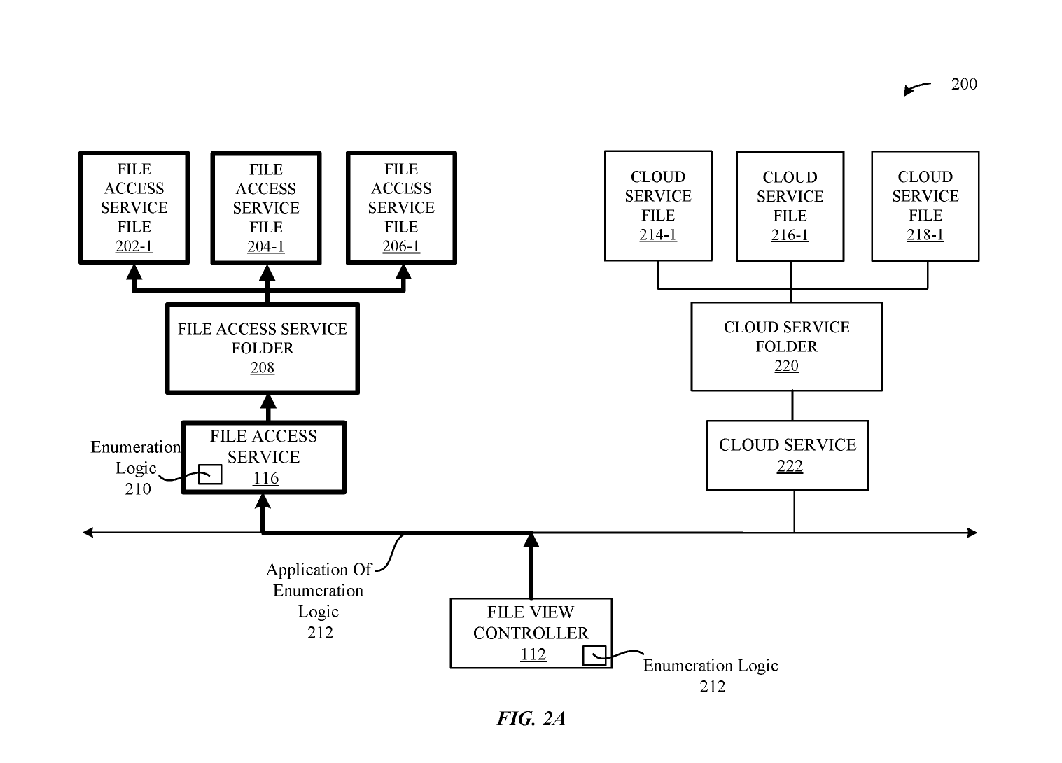

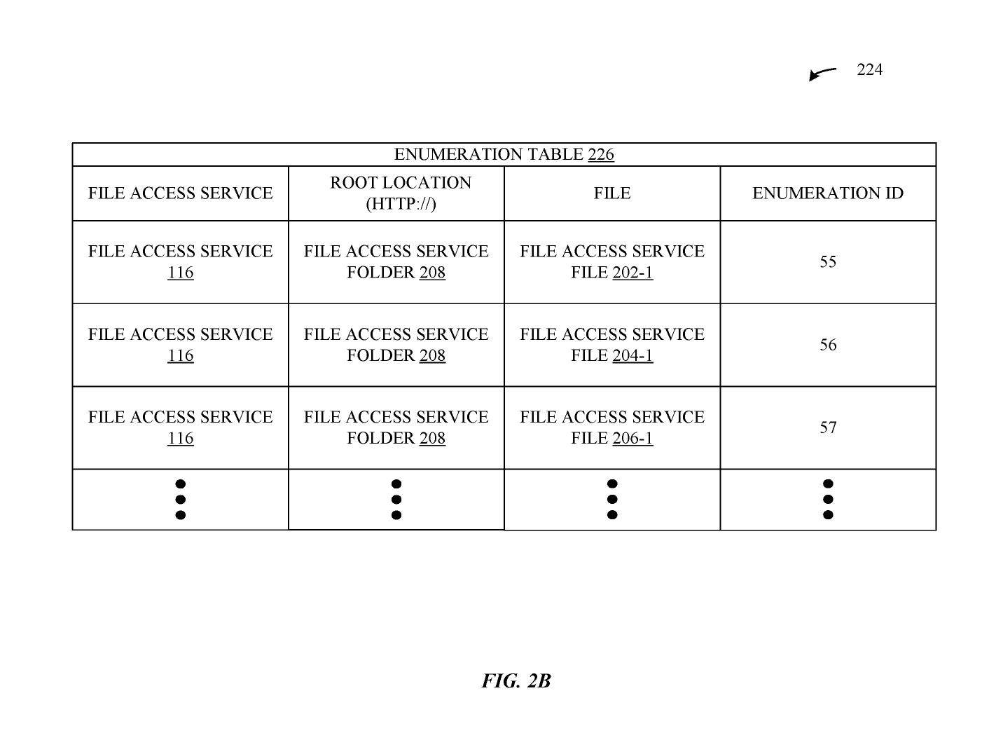

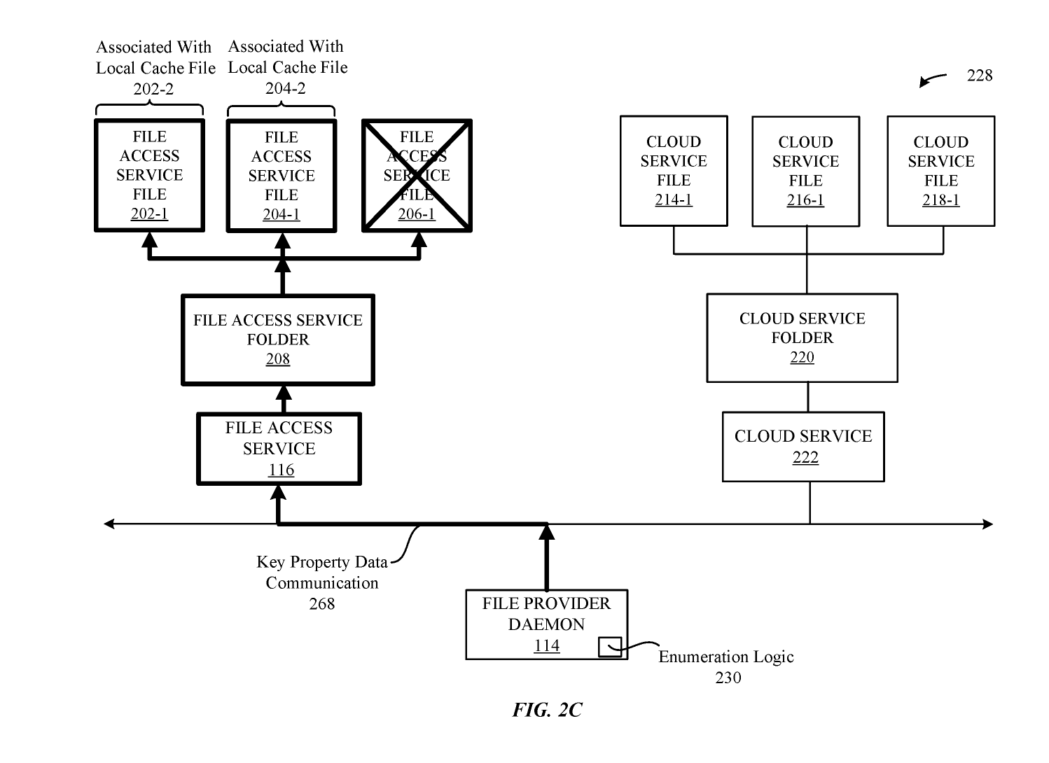

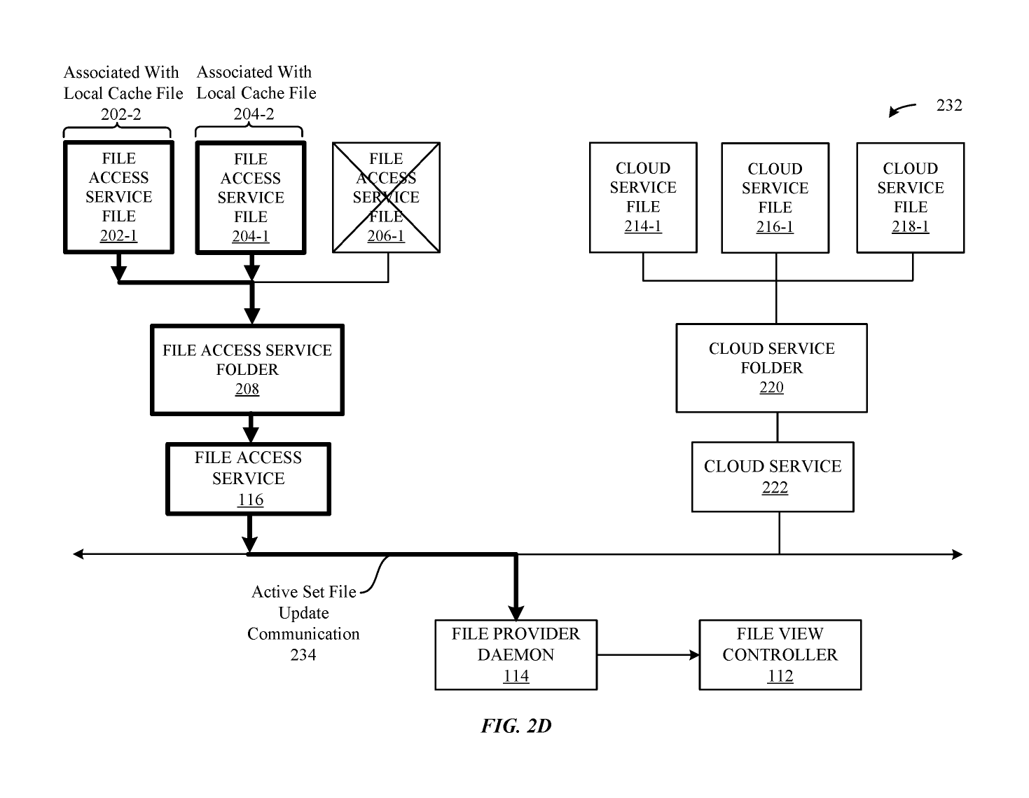

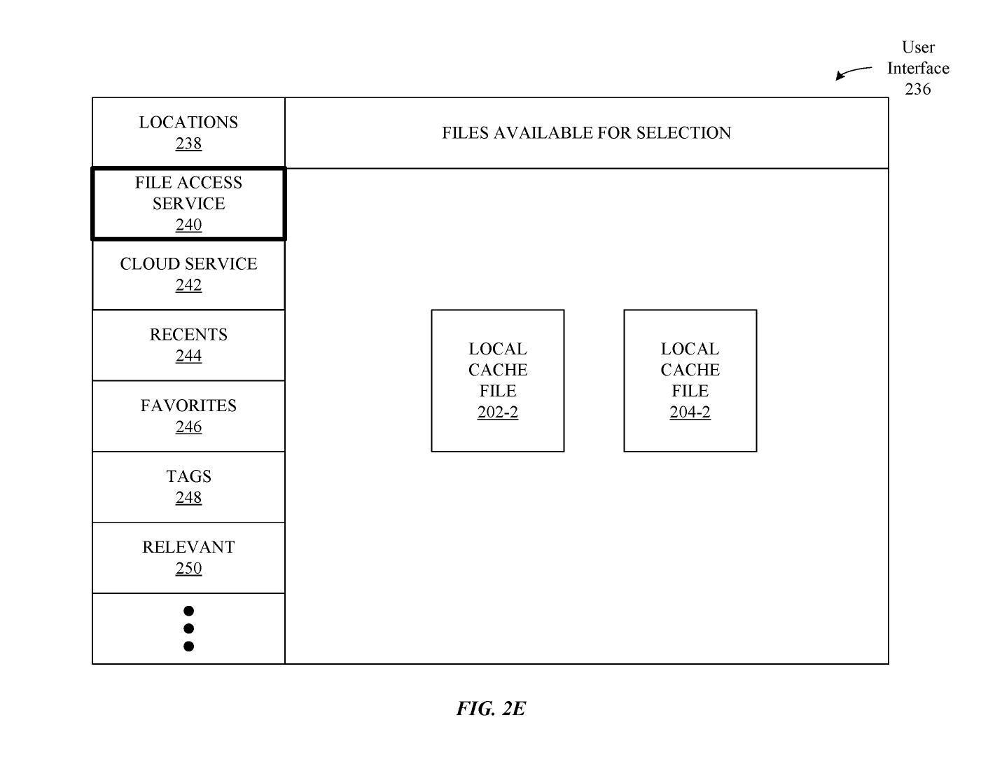

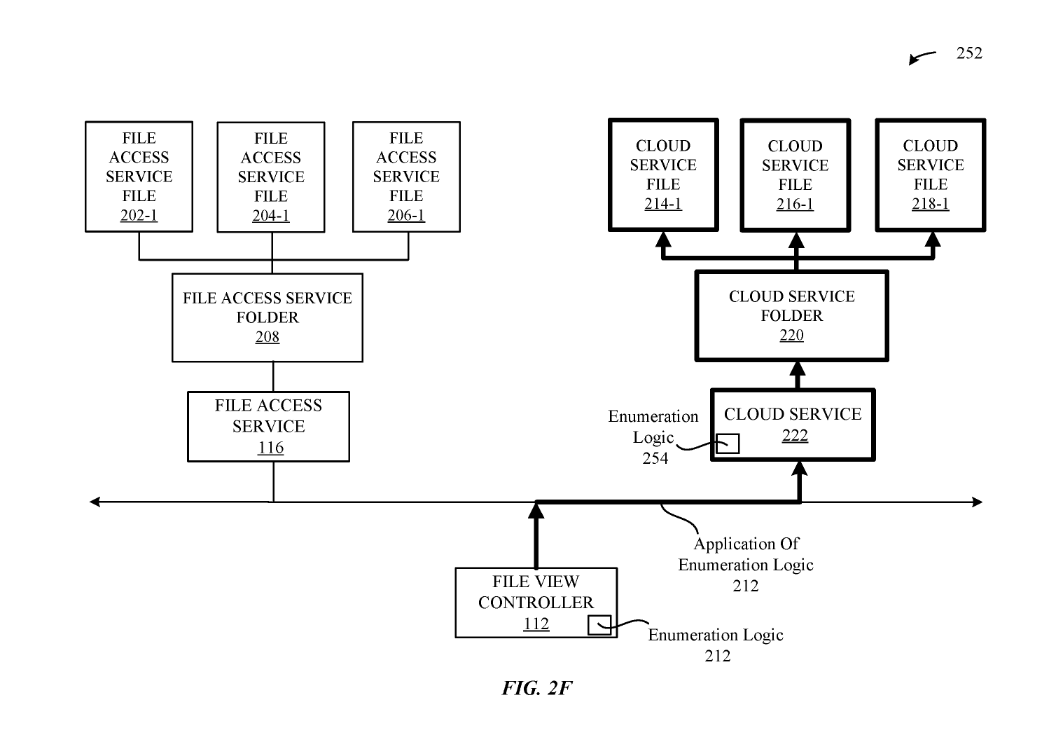

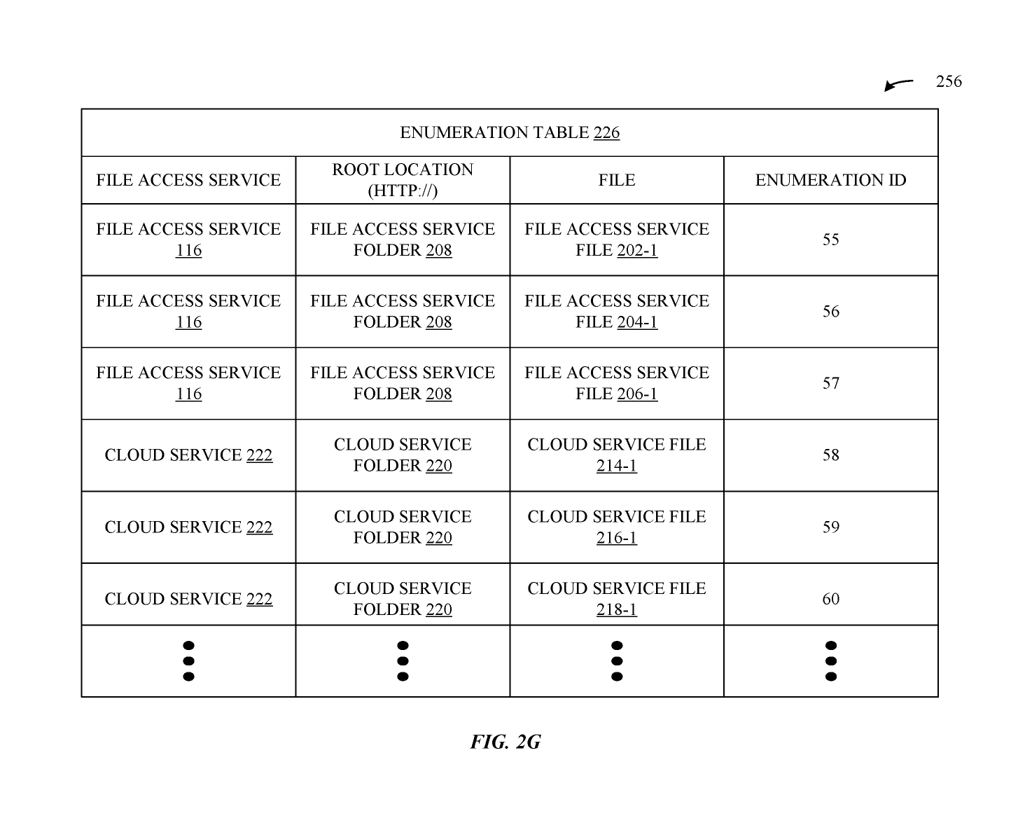

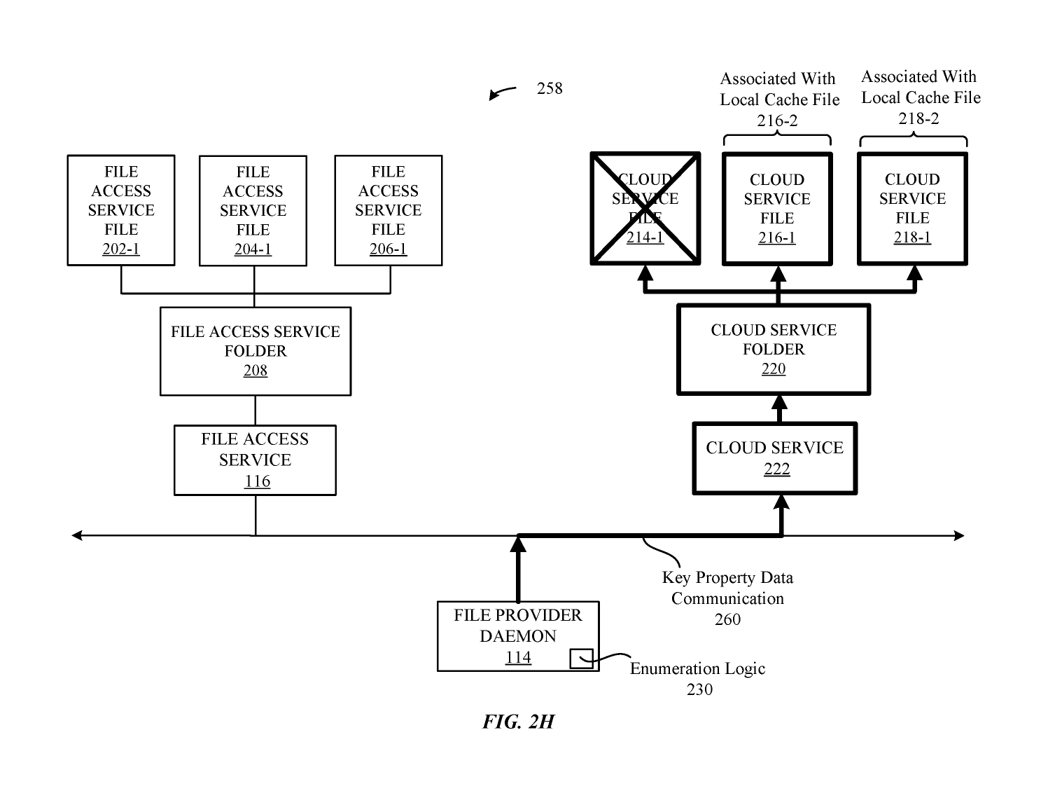

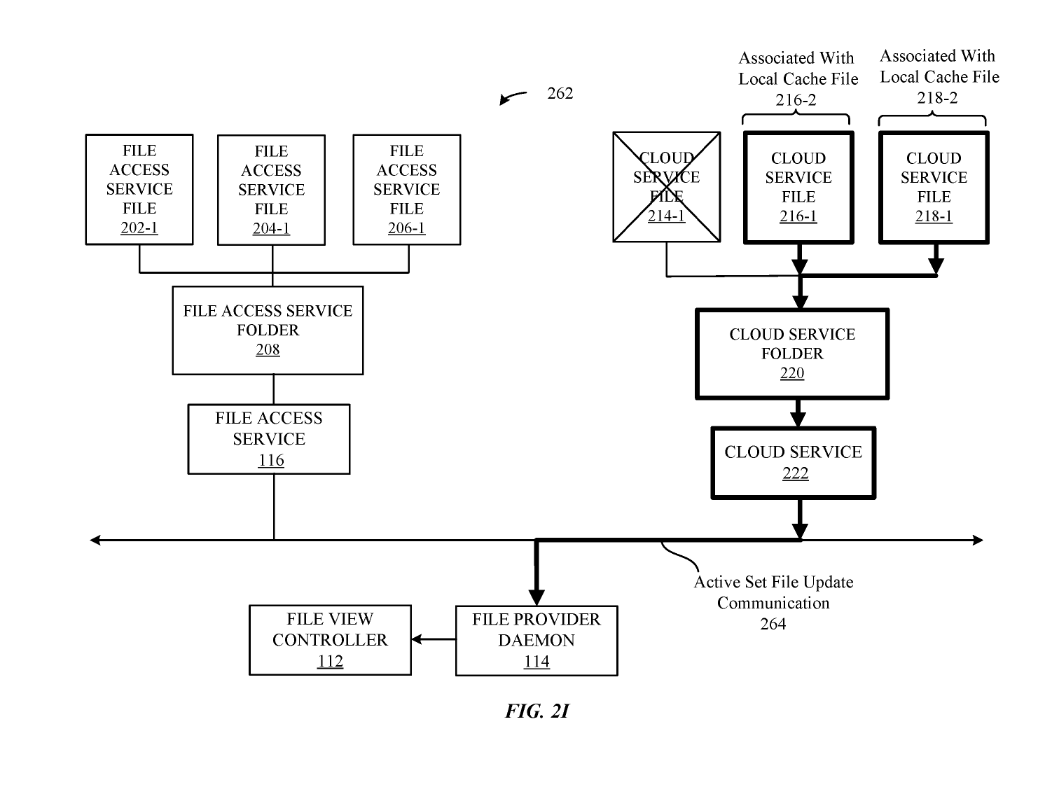

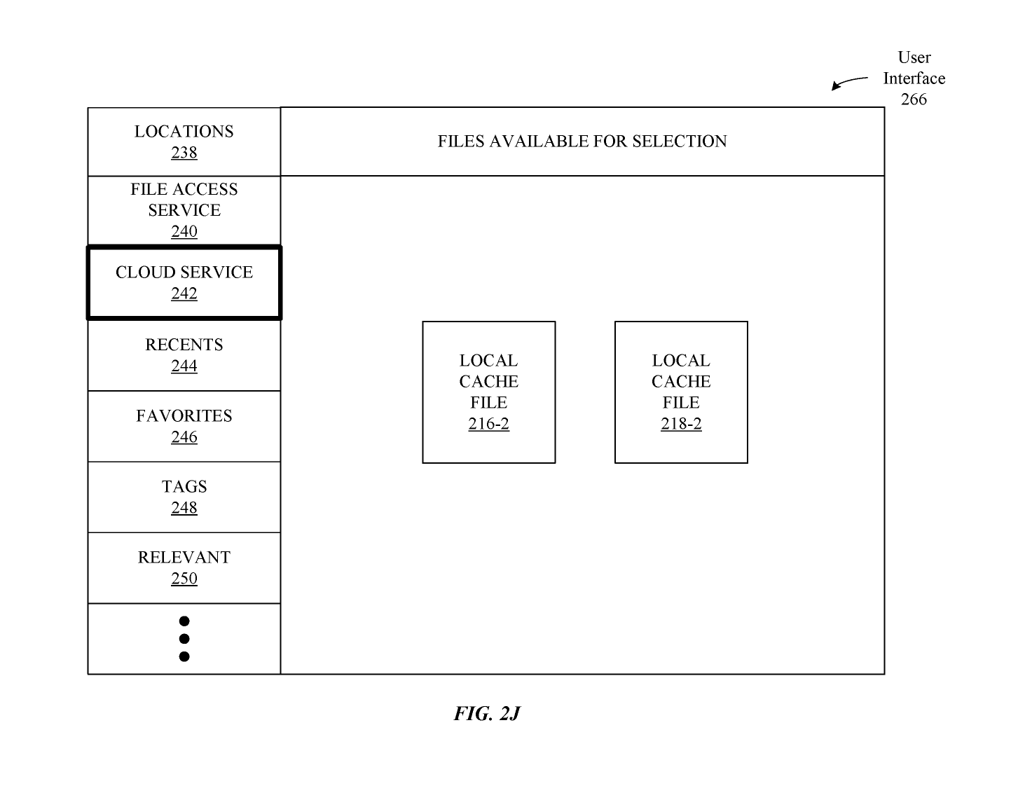

Accordingly, FIG. 1 provides a high-level overview of different hardware/software architectures that can be implemented by computing device 102 in order to carry out the various techniques described herein. A more detailed breakdown of these techniques will now be provided below in conjunction with FIGS. 2A-2J, 3A-3C, 4A-4C, 5, 6, 7 and 8. As described in greater detail below, these components can be utilized to assist in the generation of dynamic and customizable user interfaces that can quickly display relevant files to a user.

FIGS. 2A-2E illustrate exemplary file enumeration/synchronization procedures that can be performed to enable relevant files associated with a local file system to be efficiently accessed, according to some embodiments. According to some embodiments, the local file system can be stored on a client device. In accordance with the embodiment depicted in FIG. 2A, the file access service 116 can provide access to a local file system resident on the computing device 102. As illustrated by the enumeration procedures 200 depicted in FIG. 2A, the file view controller 112 can access the file access service 116 and a cloud service 222 (which includes cloud service folder 220 and a respective set of files, cloud service files 214-1, 216-1, and 218-1). According to some embodiments, the file view controller 112 can monitor user activity to determine when a user selects a file of interest from the file access service 116. As shown in FIG. 2A, the file access service 116 can include a file access service folder 208 that includes file access service files 202-1, 204-1, and 206-1. In response to a detection of any of the file access service files 202-1, 204-1, or 206-1 being selected, the file view controller 112 can perform enumeration procedures in association with the file access service 116.

Prior to the performance of enumeration procedures by the file view controller 112, the file access service 116 can perform enumeration procedures on files under the domain of the file access service 116. For example, the file access service 116 can include enumeration logic 210, which can be applied to folders/files that are managed by the file access service 116, including a file access service folder 208. In this example, the enumeration logic 210 can enable the file access service 116 to perform enumeration procedures that allow the file access service 116 to gather data associated with folders/files located within the file access service folder 208. In this fashion, the file access service 116 can gather data (e.g., tag data, “recently-accessed” date information, file thumbnail images data, etc.) on the file access service files 202-1, 204-1, and 206-1. Accordingly, upon completion of the enumeration procedures, the file access service files 202-1, 204-1, and 206-1 can be a set of newly-enumerated files that are under the domain of the file access service 116. In this fashion, the selection of any of the file access service files 202-1, 204-1 or 206-1 can alert the file view controller 112 that a user is likely interested in viewing/accessing files associated with the file access service 116.

With further reference to FIG. 2A, the file view controller 112, in response to a selection of any of the file access service files 202-1, 204-1 or 206-1, can initiate the performance of enumeration operations in association with the file access service 116. In turn, the file view controller 112, using an enumeration logic 212, can selectively perform enumeration procedures to gather folder hierarchy information about a particular file system. For instance, the file view controller 112 can specifically target the performance of enumeration procedures for the file access service 116 (as depicted by the bolded arrows directed to the file access service 116, including the folders/files made accessible by the file access service 116). In this fashion, the file view controller 112 can, through application of the enumeration logic 212, gather folder hierarchy data associated with the file access service 116.

In this manner, the file view controller 112 can gather similar folder hierarchy information previously gathered by the file access service 116. Accordingly, the file view controller 112 can gather data associated with the file access service files 202-1, 204-1, and 206-1, including the locations in which the file access service files 202-1, 204-1, and 206-1 are stored within the file access service folder 208. Although FIG. 2A only depicts files located within the file access service folder 208, it is noted that the file access service 116 can include other folders/files, in addition to the file access service folder 208. During the performance of enumeration procedures, the file view controller 112 can assign an identifier to each file that is detected. In this fashion, the file view controller 112 can store a list of identifiers using a data structure.

FIG. 2B depicts an exemplary data structure that can be used to store data related to enumeration procedures performed by the file view controller 112, according to some embodiments. As illustrated in FIG. 2B, the enumeration table 226 can store various types of information associated with enumeration procedures performed by the file view controller 112 on the file access service 116. As illustrated by enumeration results storage procedures 224 in FIG. 2B, the enumeration table 226 can store an enumeration identifier for each folder/file detected by the file view controller 112 during the performance of enumeration procedures. For instance, the enumeration table 226 can store data that includes the name of the file access service 116. As shown in FIG. 2B, the file access service folder 208 can be a root-level folder within the file access service 116. Accordingly, the root-level location of the file access service folder 208 can be stored within the enumeration table 226. Additionally, the enumeration table 226 can store enumeration IDs assigned to the file access service files 202-1, 204-1 and 206-1 (e.g., the enumeration IDs 55-57, respectively). Using the enumeration IDs corresponding to the file access service files 202-1, 204-1 and 206-1, the file provider daemon 114 can identify locally cached files that correspond to the file the access service files 202-1, 204-1 and 206-1. As described in greater detail herein, the file provider daemon 114 can use data stored in the enumeration table 226 to receive, via active set synchronization procedures, updated versions of the file access service files 202-1, 204-1 and 206-1.

FIG. 2C depicts exemplary active set synchronization procedures (e.g., active set synchronization procedures 228), according to some embodiments. According to some embodiments, the computing device 102 can store one or more locally cached files, such as local cache files 202-2 and 204-2. The local cache file 202-2 can be a locally cached version of a file associated with an active set of files. The local cache file 204-2 can be a locally cached version of a different file associated with the active set of files. In this fashion, as depicted in FIG. 2C, the file access service file 202-1 and the local cache file 202-2 can be associated with a same file that is associated with the active set of files. In a similar fashion, the file access service file 204-1 and the local cache file 204-2 can be associated with a same file—different from the file that associates the file access service file 202-1 and the local cache file 202-2—that is also associated with the active set of files.

The file provider daemon 114 can be configured to perform synchronization operations that enable the file access service 116 to detect changes within files that are associated with an active set using key property data identified by the file provider daemon 114. The file provider daemon 114 can communicate different types of key property data to the file access service 116. For instance, according to some embodiments, the file provider daemon 114 can identify/communicate key property data that can include, but is not limited to, last-accessed/last-modified data, tag data (e.g., files “favorited” by a user), recently-deleted data, shared file data, new file data, and the like. In this fashion, key property data can include metadata that allows the file access service 116 and the cloud service 222 to associate one or more files within their respective domains with one or more files locally cached files—locally cached files associated with an active set of files.

With further reference to the active set synchronization procedures 228 in FIG. 2C, the file provider daemon 114 can include enumeration logic 230 to engage in synchronization operations. In one scenario, the file provider daemon 114, using the enumeration logic 230, can engage in communications with the file access service 116 to provide key property data to the file access service 116. For instance, as illustrated in FIG. 2C, the file provider daemon 114 can communicate, via key property data communication 268 (depicted as bolded arrows), key property data to the file access service 116.

Using the key property data, the file access service 116 can identify the association between the file access service file 202-1 and the local cache file 202-2 and the association between the file access service file 204-1 and the local cache file 204-2. According to some embodiments, the file access service 116, based on the key property data, can recognize that the file access service file 206-1 is not part of an active set of files (depicted as an “X”). The key property data provided by the file provider daemon 114 allows the file access service 116 to detect modifications associated with the file access service files 202-1 and 204-1 and communicate, to the file provider daemon 114, the modification information.

For instance, FIG. 2D depicts exemplary active set data update communications (e.g., the active set data update procedures 232), according to some embodiments. Based on detected modifications made to the file access service files 202-1 and 204-1, the file access service 116 can communicate, via active set file update communication 234 (depicted as bolded arrows), modification information related to each file to the file provider daemon 114. For instance, active set file update communication 234 can include data that indicates that the file access service files 202-1 and 204-1 have been updated, modified, deleted, and so on.

Using data included in active set file update communication 234, the file provider daemon 114 can perform synchronization procedures that identify an up-to-date version of a file associated with an active set of files. The method in which the file provider daemon 114 performs synchronization procedures can be based on the manner in which the file provider daemon 114 is configured to handle conflicting versions of one or more files associated with an active set.

For example, according to some embodiments, the file provider daemon 114 can be configured to recognize “last-accessed” date data. In this manner, the file provider daemon 114 can compare files to determine which file was last accessed by a user with permission to access the file. In this fashion, a file associated with an active set can be synchronized by the file provider daemon 114 according to any modifications made to the last accessed version of the file.

For instance, with further reference to FIG. 2D, the file provider daemon 114 can compare the last-accessed dates of the local cache files 202-2 and 204-2 to the last-accessed dates of the file access service files 202-1 and 204-1, respectively. According to some embodiments, provided the file access service file 202-1 includes a more recent “last-accessed” date than the corresponding local cache file 202-2, the local cache file 202-2 can be overwritten to include any modifications included in the file access service file 202-1 that is detected by the file access service 116.

According to some embodiments, provided the file access service file 202-1 includes a less recent “last-accessed” date than the local cache file 202-2, the file access service file 202-1 can be overwritten to include any modifications included in the local cache file 202-2 that are detected by the file access service 116. According some embodiments, the file provider daemon 114 can communicate the modifications—included in the local cache file 202-2—to a file provider. In this manner, according to some embodiments, a different computing device (e.g., a different client device similar to computing device 102) can separately access a version of the file associated with local cache file 202-2 that includes the modifications included in local cache file 202-2. Using similar procedures to compare the last accessed dates of the local cache file 204-2 and the file access service file 204-1, the file provider daemon 114 can determine whether the local cache file 204-2 should be overwritten to include any modifications included in the file access service file 204-1, or vice-versa.

According to some embodiments, the file provider daemon 114 can be configured to recognize metadata (e.g., tag data) specified by a user to handle conflicting versions of files associated with an active set. For example, according to some embodiments, tag metadata can express conditions that prescribe when the local cache files 202-2 and/or 204-2 should include modifications of the file access service files 202-1 and 204-1, respectively, or vice-versa. According to some embodiments, the file provider daemon 114 can send communications to the file view controller 112 to display a file that displays the conflicting versions of files associated with an active set. In this fashion, the user can be presented, via the file view controller 112, with an option of selecting an interesting version of the conflicted file associated with an active set.

FIG. 2E depicts an exemplary user interface display generated by the file view controller 112, according to some embodiments. As depicted in user interface 236, the file view controller 112 can include a number of different graphical user interface (GUI) object buttons, such as locations button 238, file access service button 240, cloud service button 242, recents button 244, favorites button 246, tags button 248, and relevant button 250. Although not depicted in FIG. 2E, according to some embodiments, the locations button 238 can be selected to display a current position with a file system hierarchy (e.g., root-level folder).

The file access service button 240 can be selected to display a list of files associated with the file access service 116 (described throughout FIGS. 2A-2D). Accordingly, the file access service button 240 can be selected to display thumbnail images associated with an up-to-date version of the active set file associated with the file access service file 202-1/the local cache file 202-2. For instance, as depicted in FIG. 2E, based on data received from the active set synchronization procedures performed by the file provider daemon 114, the file view controller 112 can display a thumbnail image associated with the local cache file 202-2 that includes the modifications detected by file access service 116 with respect to file access service file 202-1.

Similarly, a thumbnail image associated with an up-to-date version of the active set file associated with the file access service file 204-1/the local cache file 204-2 can also be displayed. For instance, as depicted in FIG. 2E, based on data received from the active set synchronization procedures performed by the file provider daemon 114, the file view controller 112 can display a thumbnail image associated with the local cache file 204-2 that includes the modifications detected by file access service 116 with respect to file access service file 204-1.

In this fashion, the file view controller 112 can allow a user to quickly access an up-to-date version of a file made accessible by file access service 116 in a manner that does not require the user to have any knowledge of the folder hierarchy of the file system managed by the file access service 116. As will be discussed in greater detail herein, cloud service button 242, recents button 244, favorites button 246, tags button 248, and relevant button 250 can each be individually selected to dynamically display one or more relevant files of interest to the user.

FIGS. 2F-2J illustrate exemplary file enumeration/synchronization procedures that can performed to enable relevant files associated with a cloud-based file system to be efficiently accessed, according to some embodiments. In accordance with the embodiment depicted in FIG. 2F, a cloud service 222 can represent a file system that stores files remotely from the computing device 102. In this fashion, the file view controller 112 can monitor user activity to determine when a user selects a file of interest from cloud service 222. As illustrated in FIG. 2F, the cloud service 222 can include a cloud service folder 220 that includes cloud service files 214-1, 216-1, and 218-1. In response to a detection of any of the cloud service files 214-1, 216-1, or 218-1 being selected, the file view controller 112 can perform enumeration procedures on the cloud service 222.

Prior to the performance of enumeration procedures by the file view controller 112, the cloud service 222 can perform enumeration procedures on files under the domain of the cloud service 222. As illustrated by the enumeration procedures 252 depicted in FIG. 2F, the cloud service 222 can include enumeration logic 254 that can be applied to folders/files stored therein, including a cloud service folder 220. Enumeration logic 254 can enable the cloud service 222 to perform enumeration procedures that are similar to enumeration procedures described herein with respect to the file access service 116. Accordingly, upon completion of the enumeration procedures, the cloud service files 214-1, 216-1, and 218-1 can be a set of newly-enumerated files that are under the domain of the cloud service 222. In this fashion, the selection of any of the cloud service files 214-1, 216-1 or 218-1 can alert the file view controller 112 that a user is likely interested in viewing/accessing files associated with the cloud service 222.

With further reference to FIG. 2F, the file view controller 112, in response to a selection of any of the cloud service files 214-1, 216-1 or 218-1, can initiate the performance of enumeration operations on the cloud service 222. In turn, the file view controller 112 can specifically target the performance of enumeration procedures for the cloud service 222 (as depicted by the bolded arrows directed to the cloud service 222 including folders/files made accessible by the cloud service 222). The file view controller 112 can, through application of enumeration logic 212, gather folder hierarchy data associated with the cloud service 222.

In this fashion, the file view controller 112 can gather similar folder hierarchy information previously gathered by the cloud service 222. Accordingly, the file view controller 112 can gather data associated with the cloud service files 214-1, 216-1, and 218-1, including the locations in which the cloud service files 214-1, 216-1, and 218-1 are stored within the cloud service folder 220. Although FIG. 2F only depicts files located within the cloud service folder 220, it is noted that the cloud service 222 can include other folders/files, in addition to the cloud service folder 220.

FIG. 2G depicts additional entries that can be inserted into the enumeration table 226 in response to enumeration procedures performed by the file view controller 112, according to some embodiments. As depicted in enumeration results storage procedures 256, enumeration table 226 can store data that includes the name of the cloud service 222. As shown in FIG. 2G, the cloud service folder 220 can be a root-level folder within the cloud service 222.

Accordingly, the root-level location of the cloud service folder 220 can be stored within the enumeration table 226. The enumeration table 226 can also store enumeration IDs assigned to the cloud service files 214-1, 216-1, and 218-1 (e.g., enumeration IDs 58-60, respectively). Using the enumeration IDs corresponding to the cloud service files 214-1, 216-1, and 218-1, the file provider daemon 114 can identify locally cached files that correspond to the cloud service files 214-1, 216-1 and 218-1. In this manner, the file provider daemon 114 can use data stored in the enumeration table 226 to receive, via active set synchronization procedures, updated versions of the cloud service files 214-1, 216-1 and 218-1.

FIG. 2H depicts additional exemplary active set synchronization procedures (e.g., active set synchronization procedures 258), according to some embodiments. According to some embodiments, the computing device 102 can store one or more locally cached files, such as local cache files 216-2 and 218-2. The local cache file 216-2 can be a locally cached version of a file associated with an active set of files. The local cache file 218-2 can be a locally cached version of a different file associated with the active set of files. In this fashion, as depicted in FIG. 2H, the cloud service file 216-1 and the local cache file 216-2 can be associated with a same file that is associated with the active set of files. In a similar fashion, the cloud service file 218-1 and the local cache file 218-2 can be associated with a same file—different from the file that associates the cloud service file 216-1 and the local cache file 216-2—that is also associated with the active set of files.

The file provider daemon 114 can be configured to perform synchronization operations that enable the cloud service 222 to detect changes within files that are associated with an active set using key property data identified by the file provider daemon 114. With further reference to the active set synchronization procedures 258 in FIG. 2H, the file provider daemon 114 can include enumeration logic 230 to engage in synchronization operations. In one scenario, the file provider daemon 114, using the enumeration logic 230, can engage in communications with the cloud service 222 to provide key property to the cloud service 222. For instance, as illustrated in FIG. 2H, the file provider daemon 114 can communicate, via key property data communication 260 (depicted as bolded arrows), key property data to cloud service 222.

Using the key property data, the cloud service 222 can identify the association between the cloud service file 216-1 and the local cache file 216-2 and the association between the cloud service file 218-1 and the local cache file 218-2. According to some embodiments, the cloud service 222, based on the key property data, can recognize that the cloud service file 214-1 is not part of an active set of files (depicted as an “X”). The key property data provided by the file provider daemon 114 allows the cloud service 222 to detect modifications associated with the cloud service files 216-1 and 218-1 and communicate, to the file provider daemon 114, the modification information.

For instance, FIG. 2I depicts exemplary active set data update communications (e.g., the active set data update procedures 262), according to some embodiments. Based on detected modifications made to the cloud service files 216-1 and 218-1, the cloud service 222 can communicate, via active set file update communication 264 (depicted as bolded arrows), modification information related to each file to the file provider daemon 114. For instance, active set file update communication 264 can include data that indicates that the cloud service files 216-1 and 218-1 have been updated, modified, deleted, and so on.

Using data included in active set file update communication 264, the file provider daemon 114 can perform synchronization procedures to identify an up-to-date version of a file associated with an active set of files. Using synchronization/conflict detection procedures described herein, file provider daemon 114 can configured to handle conflicting versions of one or more files associated with an active set. For example, with further reference to FIG. 2I, the file provider daemon 114 can compare the last-accessed dates of the local cache files 216-2 and 218-2 to the last-accessed dates of the cloud service files 216-1 and 218-1, respectively. According to some embodiments, provided the cloud service file 216-1 includes a more recent “last-accessed” date than the corresponding local cache file 216-2, local cache file 216-2 can be overwritten to include any modifications included in the cloud service file 216-1 that is detected by the cloud service 222.

According to some embodiments, provided the cloud service file 216-1 includes a less recent “last-accessed” date than the local cache file 216-2, the cloud service file 216-1 can be overwritten to include any modifications included in the local cache file 216-2 that are detected by the cloud service 222. According to some embodiments, the file provider daemon 114 can communicate the modifications—included in the local cache file 216-2—to a file provider. In this manner, according to some embodiments, a different computing device (e.g., a different client device similar to computing device 102) can separately access a version of the file associated with local cache file 216-2 that includes the modifications included in local cache file 216-2. Using similar procedures to compare the last accessed dates of the local cache file 218-2 and the cloud service file 218-1, the file provider daemon 114 can determine whether the local cache file 218-2 should be overwritten to include any modifications included in the cloud service file 218-1, or vice-versa.

FIG. 2J depicts an exemplary user interface display generated by the file view controller 112, according to some embodiments. As depicted in user interface 266, the cloud service button 242 can be selected to display thumbnail images associated with a list of files associated with the cloud service 222 (described throughout FIGS. 2F-2J). Accordingly, the cloud service button 242 can be selected to display a thumbnail image associated with an up-to-date version of the active set file associated with the cloud service file 216-1/the local cache file 216-2. For instance, as depicted in FIG. 2J, based on data received from the active set synchronization procedures performed by the file provider daemon 114, the file view controller 112 can display a thumbnail image associated with the local cache file 216-2 that includes the modifications detected by cloud service 222 with respect to the cloud service file 216-1.

Similarly, a thumbnail image associated with an up-to-date version of the active set file associated with the cloud service file 218-1/the local cache file 218-2 can also be displayed. For instance, as depicted in FIG. 2J, based on data received from the active set synchronization procedures performed by the file provider daemon 114, the file view controller 112 can also display a thumbnail image associated with the local cache file 218-2 that includes the modifications detected by the cloud service 222 with respect to cloud service file 218-1. In this fashion, the file view controller 112 can allow a user to quickly access an up-to-date version of a file made accessible by cloud service 222 in a manner that does not require the user to have any knowledge of the folder hierarchy of the file system managed by the cloud service 222.

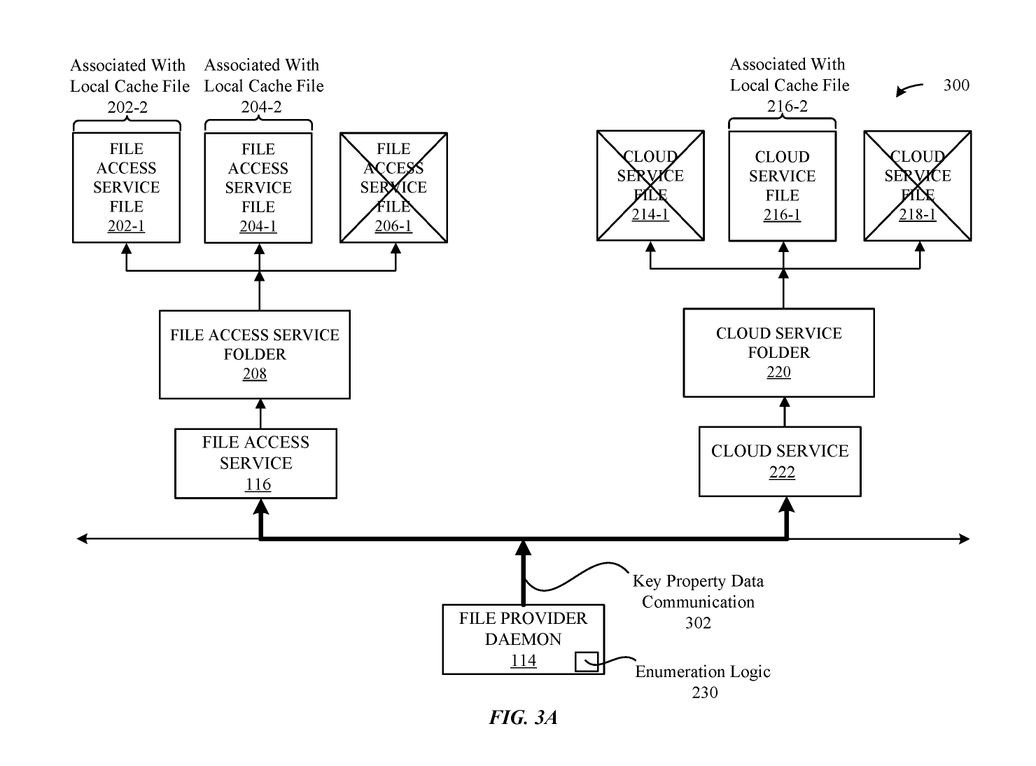

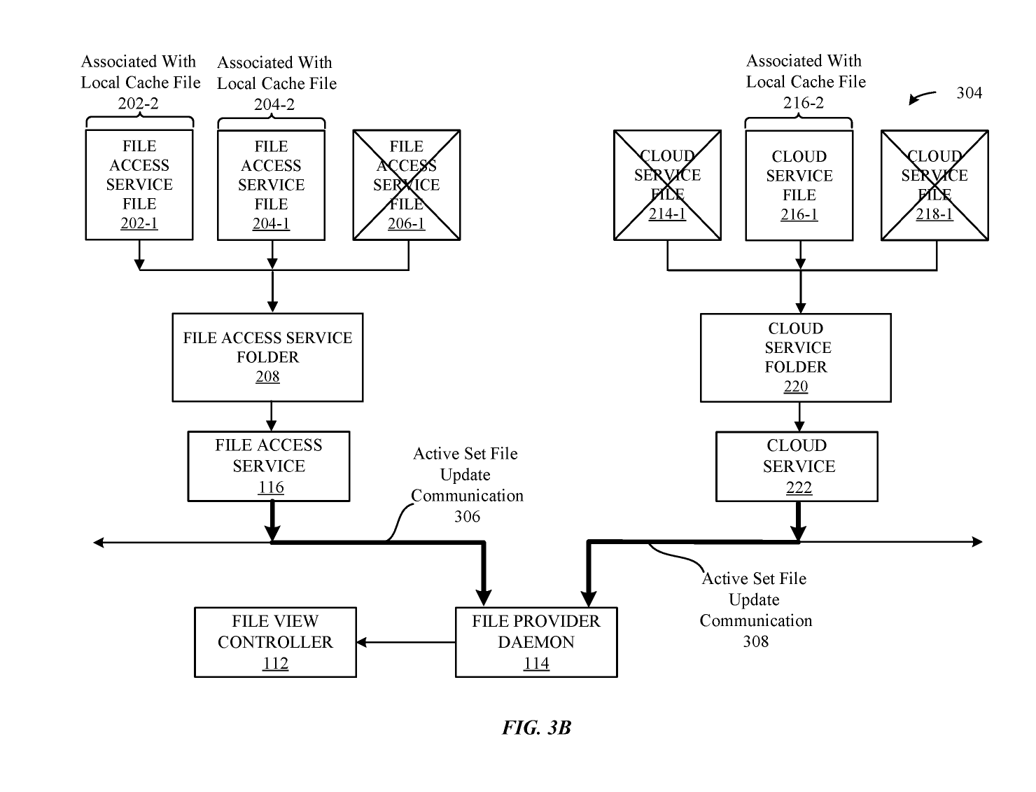

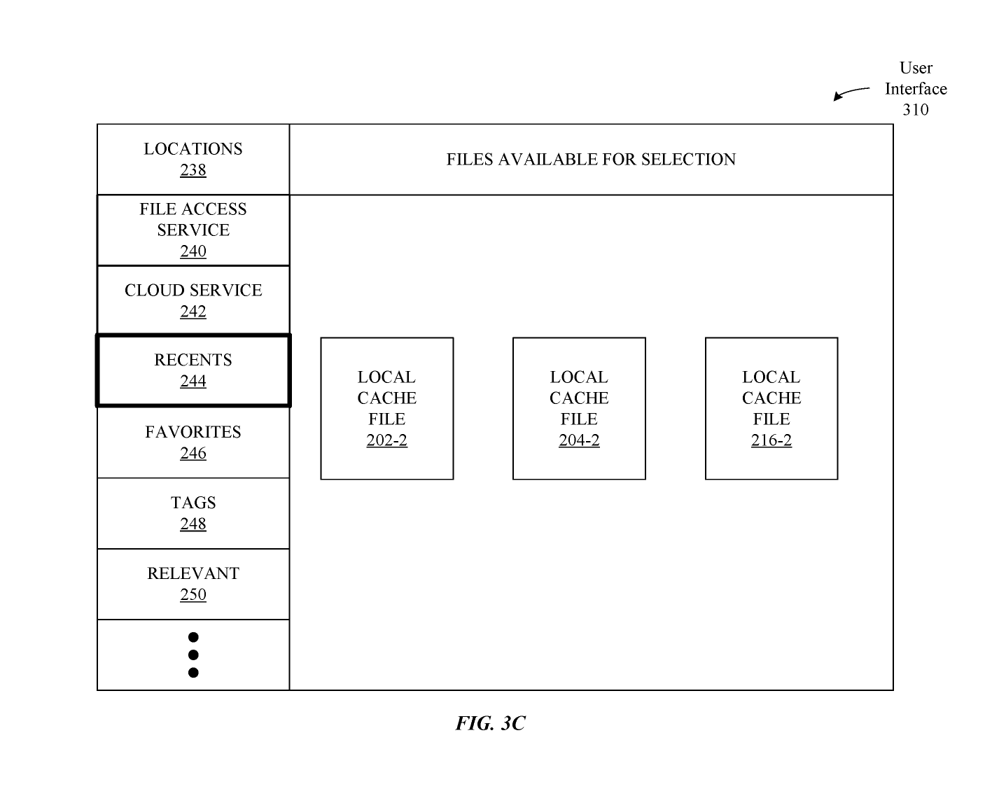

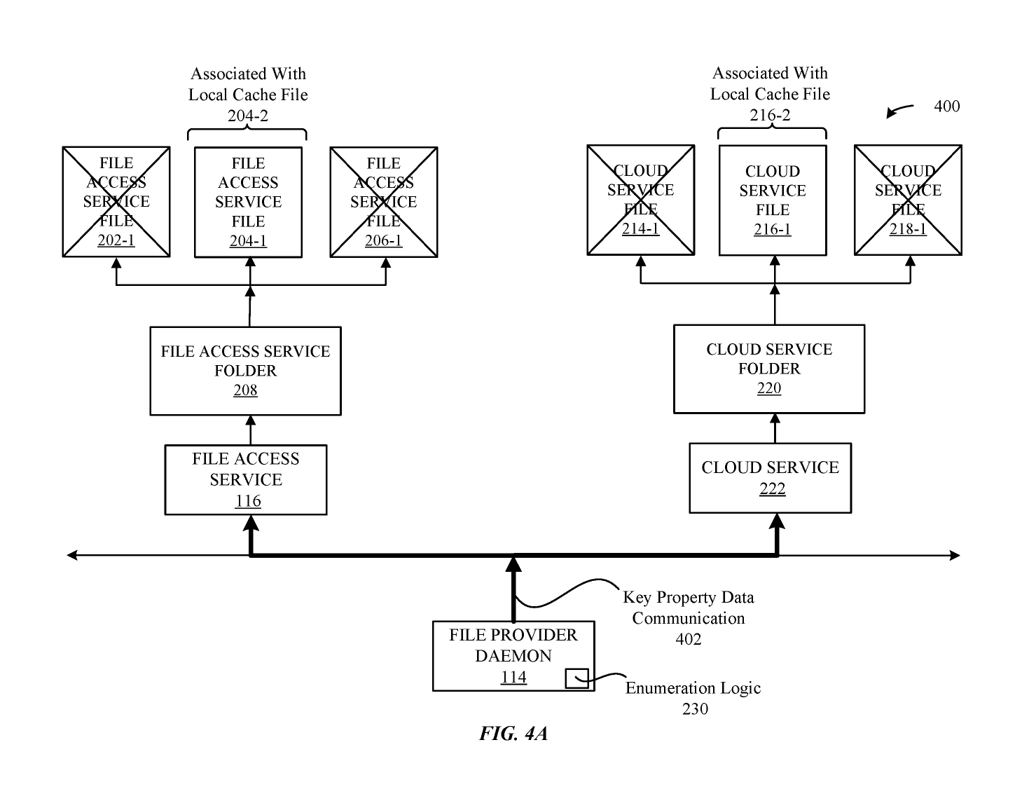

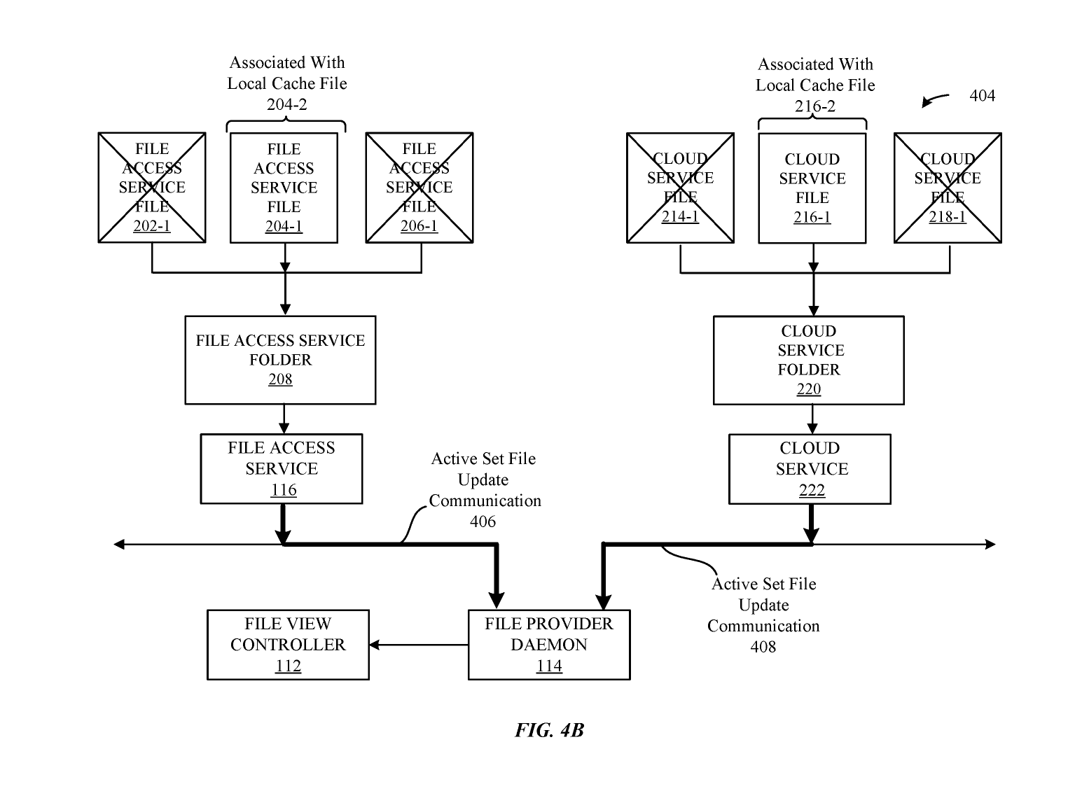

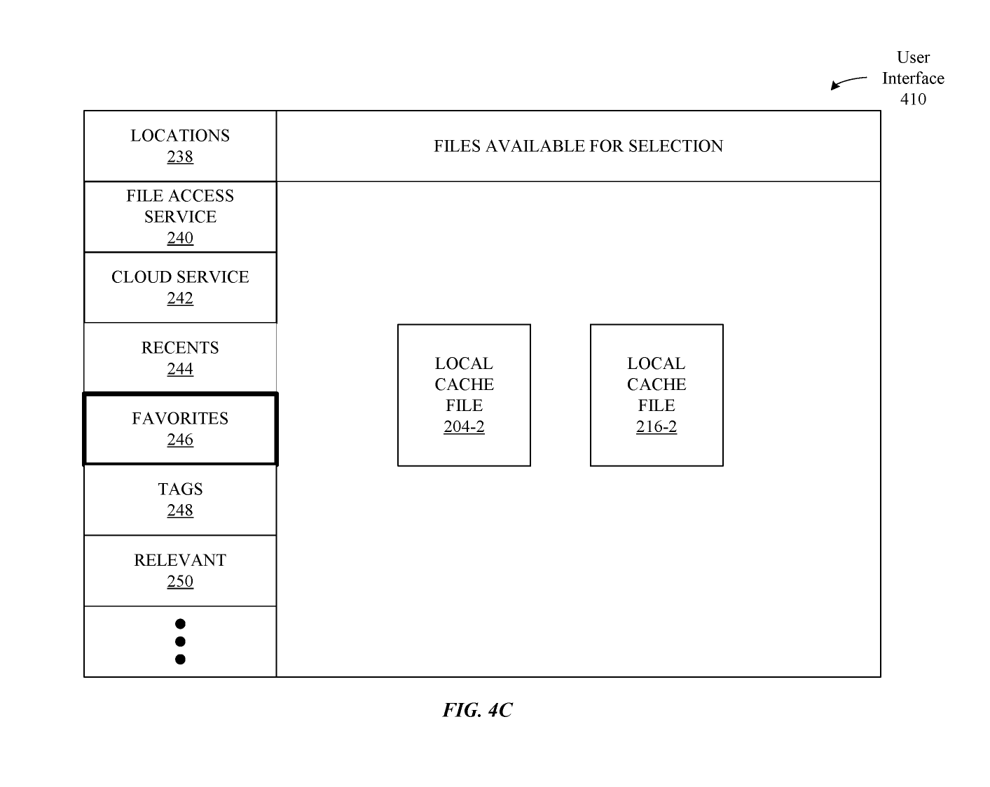

FIGS. 3A-3C and 4A-4C illustrate exemplary file enumeration/synchronization procedures that can be performed to enable relevant files associated with customizable categories to be efficiently accessed, according to some embodiments. In particular, FIG. 3A depicts additional exemplary active set synchronization procedures that can be used to dynamically display files of interest for customized categories, according to some embodiments. For instance, according to some embodiments, a user may be interested in viewing/editing one or more “recent” files. In this fashion, according to some embodiments, a user may be interested in viewing/editing files that were recently accessed by the user or a different user who has permission to access the one or more files of interest to the user.

Accordingly, the threshold for establishing a “recent” file can be customized based on a threshold that can define what the user specifies as “recent.” For example, according to some embodiments, a “recent” threshold can be based on “last-accessed” date data established for one or more files (e.g., different word processing documents) associated with a same application (e.g., word processing application capable of launching each word processing document). In this fashion, at least one file from among a number of different files associated with a same application can be considered “recent” based on the last-accessed date data of the file relative to the other files associated with the same application.

Accordingly, several different applications stored on the computing device 102 can include at least one file that can be categorized in accordance with the “recent” threshold based on the file's last-accessed date data. In this manner, each file categorized as “recent” for a respective application can be associated with an active set identified by the file provider daemon 114 and synchronized using the active set synchronization procedures described herein. Accordingly, file access service 116 and cloud service 222 can each be associated with a locally cached version of a file categorized as “recent.”

For instance, in accordance with active set synchronization procedures 300 depicted in FIG. 3A, the file access service files 202-1 and 204-1—and the cloud service file 216-1—can each be associated with different files that are respectively categorized as a “recent” file of interest to the user for different applications that can be executed on the computing device 102. In this fashion, the file access service file 202-1 can be associated with a same “recent” file as the local cache file 202-2. Also, the file access service file 204-1 can be associated with a same “recent” file as the local cache file 204-2. Additionally, the cloud service file 216-1 can be associated with a same “recent” file as the local cache file 216-2.

Using similar procedures described herein, the file provider daemon 114 can be configured to perform synchronization operations that enable different file systems (e.g., file access service 116 and cloud service 222) to monitor key property data, within their respective managed file systems, that are related to the recent files included in an active set. As depicted in FIG. 3A, using data included in key property data communication 302, the file access service 116 can identify the association between the file access service file 202-1 and the local cache file 202-2 and the association between the file access service file 204-1 and the local cache file 204-2. Based on similar data, the cloud service 222 can identify the association between cloud service file 216-1 and the local cache file 216-2. In this fashion, the file access service 116 and the cloud service 222 can monitor their respective files that are included in the active set and communicate any modification information associated with their respective active set files.

FIG. 3B depicts exemplary active set data update communications, according to some embodiments. As depicted in active set data update procedures 304 in FIG. 3B, the file access service 116, based on monitoring the file access service files 202-1 and 204-1, can determine that both files were modified by a user who has permission to modify file access service files 202-1 and 204-1. In response to detecting the modifications, the file access service 116 can communicate, via an active set file update communication 306 (depicted in bolded arrows), the changes in each file (or the modified versions of the file access service files 202-1 and 204-1) to the file provider daemon 114. For instance, the active set file update communication 306 can include data that indicates whether any of the file access service files 202-1 and 204-1 have been updated, modified, deleted, and so on.

Additionally, as depicted in FIG. 3B, the cloud service 222, based on monitoring the cloud service file 216-1, can determine that the cloud service file 216-1 was also modified. In response to detecting the modifications, the cloud service 222 can communicate, via an active set file update communication 308, the changes in the cloud service file 216-1 (or the modified version of the cloud service file 216-1) to the file provider daemon 114. According to some embodiments, the active set file update communication 308 can take the form of a periodic data “push” communication issued by the cloud service 222 to the file provider daemon 114. According to some embodiments, the file provider daemon 114 can be configured to receive active set file update communications 306 and 308 at the same time (e.g., based on a pre-determined synchronization period) or at different times (e.g., based on real-time updates, provided by the file access service 116 and the cloud service 222, associated with a respect active set file).

Using data included in active set file update communications 306 and 308, the file provider daemon 114 can perform the synchronization/conflict detection procedures described herein. For example, with further reference to FIG. 3B, the file provider daemon 114 can compare the last-accessed dates of the local cache files 202-2, 204-2, and 216-2 to the last-accessed dates of the file access service files 202-1, 204-1, and the cloud service file 216-1, respectively. According to some embodiments, provided the file access service file 202-1 includes a more recent “last-accessed” date than the corresponding local cache file 202-2, local cache file 202-2 can be overwritten to include any modifications included in the file access service file 202-1 that is detected by the file access service 116.

According to some embodiments, provided the file access service file 202-1 includes a less recent “last-accessed” date than the local cache file 202-2, the file access service file 202-1 can be overwritten to include any modifications included in the local cache file 202-2 that are detected by the file access service 116. According to some embodiments, the file provider daemon 114 can communicate the modifications—included in the local cache file 202-2—to a file provider. In this manner, according to some embodiments, a different computing device (e.g., a different client device similar to computing device 102) can separately access a version of the file associated with the local cache file 202-2 that includes the modifications included in the local cache file 202-2.

Also, using similar procedures to compare the last accessed dates of the local cache file 204-2 and the file access service file 204-1, the file provider daemon 114 can determine whether the local cache file 204-2 should be overwritten to include any modifications included in the file access service file 204-1, or vice-versa. Furthermore, using similar procedures to compare the last accessed dates of the local cache file 216-2 and the cloud service file 216-1, the file provider daemon 114 can determine whether the local cache file 216-2 should be overwritten to include any modifications included in the cloud service file 216-1, or vice-versa.

FIG. 3C depicts how customized folders can be used to intelligently display files for selection, according to some embodiments. As depicted in user interface 310 in FIG. 3C, recents button 244 can be selected to display the local cache files 202-2, 204-2, and 216-2. Accordingly, using the synchronization procedures described herein, the recents button 244 can be selected to display a thumbnail image associated with an up-to-date version of the active set file associated with the file access service file 202-1/the local cache file 202-2. Similarly, a thumbnail image associated with an up-to-date version of the active set file associated with the file access service file 204-1/the local cache file 204-2 can also be displayed. Furthermore, a thumbnail image associated with an up-to-date version of the active set file associated with the cloud service file 216-1/the local cache file 216-2 can also be displayed. In this fashion, the file view controller 112 can allow a user to quickly access an up-to-date version of one or more recent files that are of interest to the user.

FIG. 4A depicts additional exemplary active set synchronization procedures, according to some embodiments. For instance, according to some embodiments, a user may be interested in viewing files that have been accessed several times, where a file accessed several times can be categorized as “favorite” file. In this fashion, according to some embodiments, each “favorite” file can be included as part of an active set of files given the user's interest in each file. According to some embodiments, the category threshold for establishing a “favorite” file can be pre-determined. According to some embodiments, “favorite” file thresholds can be set using ranking procedures (e.g., sparse rank index), manual user indications, and so on.

In accordance with the active set synchronization procedures 400 depicted in FIG. 4A, according to some embodiments, local cache file 204-2 can include metadata that indicates a respective association with a respective “favorite” file. In this fashion, the file access service file 204-1 can be associated with a same “favorite” file as local cache file 204-2. In a similar fashion, the cloud service file 216-1 can be associated with a same “favorite” file as a local cache file 216-2.

In this fashion, the file access service 116 can use stored key property data included in key property data communication 402 (depicted in bolded arrows), provided by the file provider daemon 114, to identify the association between the file access service file 204-1 and the local cache file 204-2 with respect to a particular “favorite” file included in an active set. In a similar fashion, the cloud service 222 can use stored key property data included in the key property data communication 402 to identify the association between the cloud service file 216-1 and the local cache file 216-2 with respect to a different “favorite” file included in the active set.

As depicted in active set data update procedures 404 in FIG. 4B, the file access service 116, based on monitoring the file access service file 204-1, can determine that the file access service file 204-1 was modified. In response to detecting the modifications, the file access service 116 can communicate, via active set file update communication 406 (depicted as bolded arrows), the changes in the file access service file 204-1 (or the modified version of the file access service file 204-1) to the file provider daemon 114. Additionally, as depicted in FIG. 4B, the cloud service 222, based on monitoring the cloud service file 216-1, can determine that the cloud service file 216-1 was modified. In response to detecting the modifications, the cloud service 222 can communicate, via active set file update communication 408 (depicted as bolded arrows), the changes in the cloud service file 216-1 (or the modified version of the cloud service file 216-1) to the file provider daemon 114.

Using data included in the active set file update communications 406 and 408, the file provider daemon 114 can perform synchronization procedures that allow locally cached versions of different “favorite” files to be updated if necessary. For example, the file provider daemon 114 can perform synchronization procedures for “favorite” files included in an active set using the procedures described herein. In this fashion, the file provider daemon 114 can compare the “last-accessed” dates of the file access service file 204-1 and local cache file 204-2.

For example, provided the file access service file 204-1 includes a more recent “last-accessed” date than the local cache file 204-2, the local cache file 204-2 can be overwritten to include any modifications included in the file access service file 204-1 that are detected by the file access service 116. According to some embodiments, provided the file access service file 204-1 includes a less recent “last-accessed” date than the local cache file 204-2, the file access service file 204-1 can be overwritten to include any modifications included in the local cache file 204-2 that are detected by the file access service 116. According to some embodiments, the file provider daemon 114 can communicate the modifications—included in the local cache file 204-2—to a file provider. In this manner, according to some embodiments, a different computing device (e.g., a different client device similar to computing device 102) can separately access a version of the file associated with the local cache file 204-2 that includes the modifications included in the local cache file 204-2.

Additionally, the file provider daemon 114 can compare the “last-accessed” dates of the cloud service file 216-1 and the local cache file 216-2. Provided the cloud service file 216-1 includes a more recent “last-accessed” date than the local cache file 216-2, the local cache file 216-2 can be overwritten to include any modifications included in cloud service file 216-1 that are detected by the file access service 116. According to some embodiments, provided the cloud service file 216-1 includes a less recent “last-accessed” date than the local cache file 216-2, the cloud service file 216-1 can be overwritten to include any modifications included in the local cache file 216-2 that are detected by the cloud service 222. According to some embodiments, the file provider daemon 114 can communicate the modifications—included in the local cache file 216-2—to a file provider. In this manner, according to some embodiments, a different computing device (e.g., a different client device similar to computing device 102) can separately access a version of the file associated with the local cache file 216-2 that includes the modifications included in the local cache file 216-2.

FIG. 4C depicts another example of how customized folders can be used to intelligently display files for selection, according to some embodiments. As illustrated in FIG. 4C, a favorites button 246 can be selected to display a list of recent “favorite” files to the user for selection. As depicted in user interface 410 in FIG. 4C, favorites button 246 can be selected to display thumbnails images associated with the local cache files 204-2 and 216-2. Accordingly, using the synchronization procedures described herein, the favorites button 246 can be selected to display thumbnail images associated with an up-to-date version of the active set file associated with the file access service file 204-1/the local cache file 204-2. Similarly, a thumbnail image associated with an up-to-date version of the active set file associated with the cloud service file 216-1/the local cache file 216-2 can also be displayed.

In a similar manner, a tags button 248 can be selected to display a list of tagged files that are tagged by a user with appropriate permissions. According to some embodiments, tagged files can be tagged by one or more users (e.g., one or more users with permissions to share access to specified tagged files). Similar to procedures for described herein, a category threshold for establishing a “tags” file can also be pre-determined. For example, a user can manually assign a tag to a file, or the file can be automatically tagged (e.g., based on its content) in accordance with one or more conditions. Accordingly, using enumeration/synchronization procedures similar to those described herein, tags button 248 can be selected to display a list of updated files that conform to the requirements established for the “tags” category.

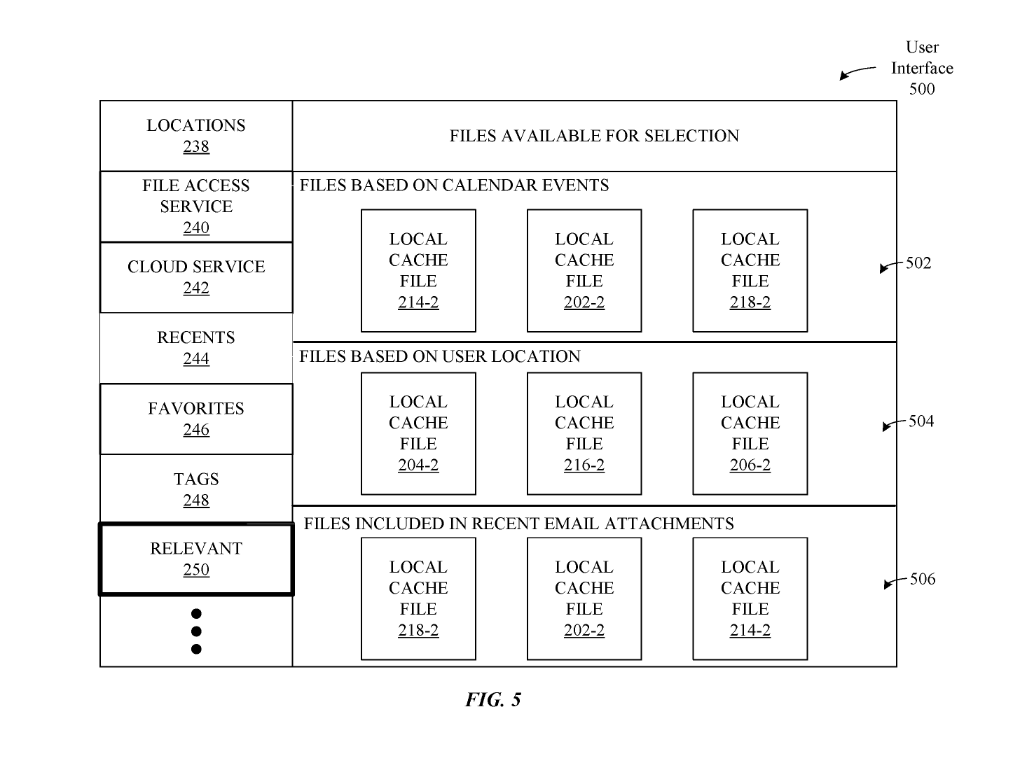

FIG. 5 illustrates an exemplary customized folder that includes different views for intelligently displaying relevant files for selection, according to some embodiments. As shown in user interface 500 in FIG. 5, a relevant button 250 can be selected to display a number of different customizable sub-category views (e.g., views 502, 504, and 506) that can each list a respective set of files that a user can consider relevant. According to some embodiments, the category threshold for establishing each different sub-category view can be pre-determined. According to some embodiments, files displayed within sub-category views can be displayed in accordance with file enumeration/synchronization procedures described herein. For example, sub-category views described herein can include any property that is based on the relevance of an event, a location, or one or more individuals, and so on.

For instance, as depicted in FIG. 5, the view 502 can display thumbnail images associated with a set of files (e.g., the local cache files 214-2, 202-2, and 218-2) that are based on calendar events. According to some embodiments, thumbnail images associated with the local cache files 214-2, 202-2, and 218-2 can be displayed based on metadata indicating that these files are relevant to an upcoming (or recently-occurred) collaboration session/meeting, e.g., based on scheduled calendar events. For instance, the local cache file 202-2 can be relevant to an upcoming meeting scheduled according to a calendar application accessible on the computing device 102. In this fashion, the user can quickly access, using the view 502, the local cache file 202-2 in anticipation of the upcoming meeting.

Additionally, the view 504 can display thumbnail images associated with a set of files (e.g., the local cache files 204-2, 216-2, and 206-2) that are based on at least one location-specific property. For instance, according to some embodiments, the thumbnail images associated with local cache files 204-2, 216-2, and 206-2 can be displayed based on metadata indicating that these files are relevant to a particular location (e.g., home, workplace, recreational location, etc.). For instance, the local cache files 204-2 and 206-2 can be workplace-related files. Thus, based on a detection of the computing device 102 (which stores cached versions of the local cache files 204-2 and 206-2) being proximate to the workplace, the thumbnail images of the local cache files 204-2 and 206-2 can be dynamically placed within the view 504. In this fashion, the user can quickly access, using the view 504, the local cache files 204-2 and 206-2 while at the workplace.

Furthermore, the view 506 can display thumbnail images associated with a set of files (e.g., the local cache files 218-2, 202-2, and 214-2) that are based on email attachments included in emails received by the user and viewed on the computing device 102. For instance, according to some embodiments, the thumbnail images associated with the local cache files 218-2, 202-2, and 214-2 can be displayed based on metadata indicating that these files are email attachments that were recently viewed/accessed by the user. In this fashion, the user can quickly access, the using the view 506, relevant email attachments without the need to navigate through a file system to locate the local cache files 218-2, 202-2, and 214-2.

According to some embodiments, one or more files included in views 502, 504, and/or 506 can be engaged in response to voice commands received from a user (e.g., using a microphone device coupled to computing device 102). For example, the computing device 102 can be configured to display, open, send (e.g., email, message, transfer, etc.), dictate, modify, move, delete, tag, etc., one or more of the files in response to voice commands received from a user. According to some embodiments, the voice commands can be analyzed using audio processing, language processing, semantics processing, and so on, to accurately identify the user's intentions, and take appropriate action(s) in response.

Although not explicitly depicted in FIG. 5, according to some embodiments, one or more files included in views 502, 504, and/or 506 can be configured for sharing among two or more users. According to some embodiments, a shared file can be made accessible via cloud service 222. In this fashion, a shared file can be associated with a number of different categories described herein (e.g., “favorites,” “recent,” “tags,” “relevant,” etc.) given that a shared file can be updated with greater frequency—relative to files restricted to single user access—due a number of different privileged users accessing the shared file. Furthermore, a shared file can undergo similar enumeration/synchronization procedures described herein. According to some embodiments, a user interface generated by file view controller 112 can include a “shared” (GUI) object button (not depicted in FIG. 5) that can be used to quickly access one or more files that shared between two or more users. Accordingly, a shared file can be associated with a number of different configurations that involve the shared file being associated with the active set of files described herein.

Accordingly, the views 502, 504, and 506 can enable the user to quickly access relevant files without requiring the user to perform tedious navigation procedures. It is noted that the foregoing examples of relevancy are merely exemplary, and that the techniques set forth herein can consider any file property when gathering files that might be of interest to the user. For example, additional views can be provided for collaboration-based (i.e., shared) files.

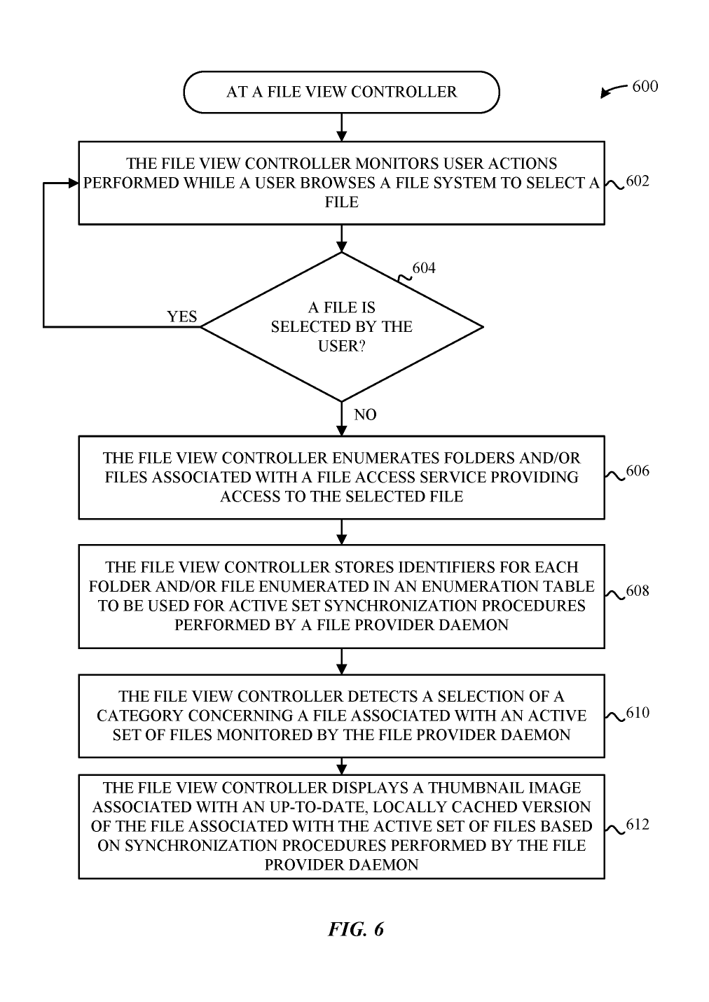

FIG. 6 illustrates a method 600 for dynamically displaying relevant files for selection, according to some embodiments. As shown in FIG. 6, the method 600 can be implemented by a file view controller (e.g., the file view controller 112 executing on the computing device 102) or other software, hardware, or combination thereof. Method 600 begins at step 602, where the file view controller monitors user actions performed while a user browses a file system to select a file. Next, at step 604, the file view controller determines whether the user selected a file. If the file view controller determines that a file was selected by the user, then file view controller enumerates folders and/or files associated with a file access service that provides access to the selected file, as detailed at step 606. Otherwise, the file view controller continues to monitor user actions performed in the manner described at step 602.

Next, at step 608, the file view controller stores identifiers for each folder and/or file enumerated in an enumeration table to be used for active set synchronization procedures performed by a file provider daemon. Next, at step 610, the file view controller detects a selection of a category associated with a file associated with an active set of files monitored by the file provider daemon. Next, at step 612, the file view controller displays a thumbnail image associated with an up-to-date, locally cached version of the file associated with the active set of files based on synchronization procedures performed by the file provider daemon.

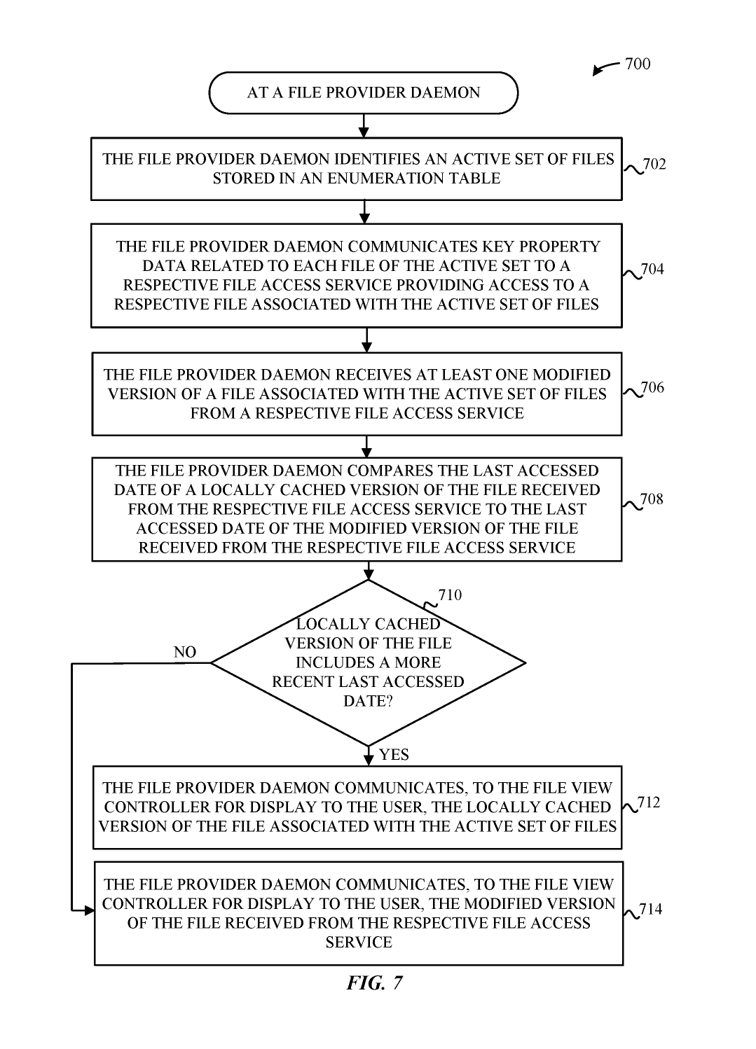

FIG. 7 illustrates a method 700 for dynamically displaying relevant files for selection, according to some embodiments. As shown in FIG. 7, the method 700 can be implemented by a file provider daemon (e.g., the file provider daemon 114 executing on the computing device 102), and begins at step 702, where the file provider daemon identifies an active set of files stored in an enumeration table. Next, at step 704, the file provider daemon communicates key property data related to each file of the active set to a respective file access service providing access to a respective file associated with the active set of files. Next, at step 706, the file provider daemon receives at least one modified version of a file associated with the active set of files from a respective file access service. Next, at step 708, the file provider daemon compares the last accessed date of a locally cached version of the file received from the respective file access service to the last accessed date of the modified version of the file received from the respective file access service.

Next, at step 710, the file provider daemon determines whether the locally cached version of the file includes a more recent last accessed date than the last accessed date of the modified version of the file received from the respective file access service. If the file provider daemon determines that the locally cached version of the file includes a more recent last accessed date, then the file provider daemon communicates, to the file view controller for display to the user, the locally cached version of the file associated with the active set of files, as detailed at step 712. Otherwise, the file provider daemon communicates, to the file view controller for display to the user, the modified version of the file received from the respective file access service, as detailed at step 714.

FIG. 8 illustrates a detailed view of a computing device 800 that can be used to implement the various components described herein, according to some embodiments. In particular, the detailed view illustrates various components that can be included in the computing device 102 illustrated in FIG. 1. As shown in FIG. 8, the computing device 800 can include a processor 802 that represents a microprocessor or controller for controlling the overall operation of the computing device 800.

The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, and so on. Still further, the computing device 800 can include a display 810 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include a wireless transceiver.

As noted above, the computing device 800 also include the storage device 840, which can comprise a single disk or a collection of disks (e.g., hard drives), and includes a storage management module that manages one or more partitions within the storage device 840. In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of applications executing on the computing device 102, including application 110, a file view controller 112, a file provider daemon 114, and a file access service 116.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for displaying files for selection at a computing device, the method comprising, at the computing device:
identifying, among at least one file access service of a plurality of file access services, a first plurality of files associated with the at least one file access service, wherein the first plurality of files is enumerated according to a first enumeration scheme used by the at least one file access service;
receiving a selection of a key property;
selecting a first subset of files from the first plurality of files, wherein the first subset of files comprises a relevant set of files based on the key property; and
displaying the first subset of files for selection.

2. The method of claim 1, wherein receiving the selection of a key property further comprises communicating data related to the key property to the at least one file access service to provide updated information associated with the first subset of files.

3. The method of claim 1, wherein the key property corresponds to a recently-used category, a tag category, a recently-deleted category, a shared file category.

4. The method of claim 1, wherein displaying, for selection, the first subset of files further comprises generating a graphical user interface (GUI) object based on the key property.

5. The method of claim 4, wherein generating the (GUI) object further comprises generating at least one file GUI object associated with a first relevant file from the relevant set of files based on a selection of the (GUI) object.

6. The method of claim 4, wherein generating the (GUI) object further comprises generating a plurality of different key property (GUI) objects based on a plurality of different key properties.

7. The method of claim 1, wherein the at least one file access service is a cloud-based file system.

8. A computing device configured to display files for selection at the computing device, the computing device comprising:
at least one processor; and
at least one memory configured to store instructions that, when executed by the at least one processor, cause the computing device to:
identifying, among at least one file access service of a plurality of file access services, a first plurality of files associated with the at least one file access service, wherein the first plurality of files is enumerated according to a first enumeration scheme used by the at least one file access service;
receiving a selection of a key property;
selecting a first subset of files from the first plurality of files, wherein the first subset of files comprises a relevant set of files based on the key property; and
displaying the first subset of files for selection.

9. The computing device as described in claim 8, wherein the step of receiving the selection of the key property further comprises communicating data related to the key property to the at least one file access service to provide updated information associated with the first subset of files.

10. The computing device as described in claim 8, wherein the key property corresponds to a recently-used category, a tag category, a recently-deleted category, a shared file category.

11. The computing device as described in claim 8, wherein the step of displaying, for selection, the first subset of files further comprises generating a graphical user interface (GUI) object based on the key property.

12. The computing device as described in claim 11, wherein the step of generating the (GUI) object further comprises generating at least one file GUI object associated with a first relevant file from the relevant set of files based on a selection of the (GUI) object.

13. The computing device as described in claim 11, wherein the step of generating the (GUI) object further comprises generating a plurality of different key property (GUI) objects based on a plurality of different key properties.

14. The computing device as described in claim 8, wherein the at least one file access service is a cloud-based file system.

15. At least one non-transitory computer readable storage medium configured to store instructions that, when executed by at least one processor included in a computing device, cause the computing device to display files for selection at the computing device, by carrying out steps that include:
identifying, among at least one file access service of a plurality of file access services, a first plurality of files associated with the at least one file access service, wherein the first plurality of files is enumerated according to a first enumeration scheme used by the at least one file access service;
receiving a selection of a key property;
selecting a first subset of files from the first plurality of files, wherein the first subset of files comprises a relevant set of files based on the key property; and
displaying the first subset of files for selection.

16. The at least one non-transitory computer readable storage medium as described in claim 15, wherein the step of receiving the selection of the key property further comprises communicating data related to the key property to the at least one file access service to provide updated information associated with the first subset of files.

17. The at least one non-transitory computer readable storage medium as described in claim 15, wherein the key property corresponds to a recently-used category, a tag category, a recently-deleted category, a shared file category.

18. The at least one non-transitory computer readable storage medium as described in claim 15, wherein the step of displaying, for selection, the first subset of files further comprises generating a graphical user interface (GUI) object based on the key property.

19. The at least one non-transitory computer readable storage medium as described in claim 18, wherein the step for generating the (GUI) object further comprises generating at least one file GUI object associated with a first relevant file from the relevant set of files based on a selection of the (GUI) object.

20. The at least one non-transitory computer readable storage medium as described in claim 18, wherein the step for generating the (GUI) object further comprises generating a plurality of different key property (GUI) objects based on a plurality of different key properties.
